(19) United States
(12) Patent Application Publication
(10) Pub. No.: US 2012/0198396 A1
(43) Pub. Date: Aug. 2, 2012

(54) METHOD OF OPTIMIZING SEMICONDUCTOR DEVICE MANUFACTURING PROCESS, METHOD OF MANUFACTURING SEMICONDUCTOR DEVICE, AND NON-TRANSITORY COMPUTER READABLE MEDIUM

(76) Inventors: Masanari KAJIWARA, Kanagawa (JP); Sachiko Kobayashi, Chiba (JP); Satoshi Tanaka, Kanagawa (JP); Kazuhiro Takahata, Kanagawa (JP); Shigeki Nojima, Kanagawa (JP); Toshiya Kotani, Tokyo (JP); Shimon Maeda, Tokyo (JP)

(21) Appl. No.: 13/237,854

(22) Filed: Sep. 20, 2011

(30) Foreign Application Priority Data
Jan. 31, 2011 (JP) 2011-017956

(51) Int. Cl. G06F 17/50

(52) U.S. Cl. 716/54

(57) ABSTRACT

A method of optimizing a semiconductor device manufacturing process according to an embodiment is a method of optimizing a semiconductor device manufacturing process in which a pattern based on circuit design is formed. The method of optimizing a semiconductor device manufacturing process according to the embodiment includes: at the time of calculation of a statistic amount based on a distribution of differences at a plurality of sites between a pattern formed by a first exposing apparatus in a first condition and a pattern formed by a second exposing apparatus in a second condition, calculating the statistic amount after applying weighting to the differences based on information on an electrical characteristic; and repeating the calculating with the second condition being changed, and selecting an condition in which the total sum becomes a minimum or equal to or less than a standard value as an optimized condition of the second exposing apparatus.

### CROSS-REFERENCE TO RELATED APPLICATIONS

This application is based upon and claims the benefit of priority from Japanese Patent Application No. 2011-017956, filed on Jan. 31, 2011; the entire contents of which are incorporated herein by reference.

### FIELD

Embodiments described herein relate generally to a method of optimizing a semiconductor device manufacturing process, a method of manufacturing a semiconductor device, and a non-transitory computer readable medium.

### BACKGROUND

In manufacturing of a semiconductor device, since sites with a small margin in terms of an electrical characteristic such as a path (critical path) where a timing margin is small cannot be easily read from a layout, it is difficult to perform the manufacturing by taking into consideration the sites in a process side. In recent lithography process design, in order to increase production yield in all product layouts of the same generation, exposing conditions (numerical aperture (NA), diaphragm, an illumination shape, and the like) are calculated and selected which can maintain a sufficient process margin with respect to both a pattern pitch and a shape permitted as a design rule. In addition, actually, in regards to an exposing apparatus performing mass production, a plurality of the apparatuses are used, and the performance varies depending on apparatus. In order to compensate for this variation, adjusted are various exposing parameters (numerical aperture (NA), an outer diameter (σ_Out) of annular illumination, an inner diameter (σ_In) of annular illumination, a tilt of a wafer to an illumination system, and the like).

### BRIEF DESCRIPTION OF THE DRAWINGS

FIG. 1 is a diagram illustrating a flow of illumination condition optimization according to a comparative example of a first embodiment;

FIG. 2 is a diagram illustrating a flow of illumination condition optimization according to the first embodiment;

FIG. 3 is a diagram illustrating an effect of tuning (illumination condition optimization) which suppresses a change of a critical path to a minimum level according to the first embodiment;

FIG. 4 is a diagram illustrating a specific example where an effect of the optimization of the first embodiment with respect to a wire line width of the critical path and a wire line width of a path other than the critical path is compared with a comparative example;

FIG. 5 is a diagram illustrating a flow of a method of optimizing a semiconductor device manufacturing process according to a comparative example of a second embodiment;

FIG. 6 is a diagram illustrating a flow of a method of optimizing a semiconductor device manufacturing process according to the second embodiment;

FIG. 7 is a diagram schematically illustrating an effect of a method of optimizing a semiconductor device manufacturing process according to the second embodiment;

FIG. 8 is a diagram illustrating a behavior of generating an exposing amount adjustment map from a dimension variation of a pattern on a wafer according to a comparative example of a third embodiment;

FIG. 9 is a diagram illustrating a behavior of generating an exposing amount adjustment map from a dimension variation of a pattern on a wafer according to the third embodiment;

FIG. 10 is a diagram illustrating a behavior of generating an exposing amount adjustment map according to another example of the third embodiment;

FIG. 11 is a diagram illustrating a behavior of generating an exposing amount adjustment map according to still another example of the third embodiment; and

FIG. 12 is a flowchart illustrating an exposing amount adjustment method according to the third embodiment.

### DETAILED DESCRIPTION

A method of optimizing a semiconductor device manufacturing process according to an embodiment is a method of optimizing a semiconductor device manufacturing process in which a pattern is formed on a semiconductor substrate based on circuit design data by an exposing process using a photomask generated from the circuit design data. The method of optimizing a semiconductor device manufacturing process according to the embodiment includes: at the time of calculation of a statistic amount based on a distribution of differences at a plurality of sites, which are determined in advance, between a pattern formed on the semiconductor substrate by a first exposing apparatus using the photomask in a first exposing condition and a pattern formed on the semiconductor substrate by a second exposing apparatus using the photomask in a second exposing condition, calculating the statistic amount after applying weighting to the differences based on information on an electrical characteristic extracted from the circuit design data; and repeating the calculating process with the second exposing condition being changed, and selecting an exposing condition in which the total sum becomes a minimum value or equal to or less than a predetermined standard value as an optimized exposing condition of the second exposing apparatus among the changed second exposing conditions.

Hereinafter, a method of optimizing a semiconductor device manufacturing process, a method of manufacturing a semiconductor device, and a non-transitory computer readable medium according to the embodiments will be described in detail with reference to the attached drawings. In addition, the present invention is not limited to the embodiments.

### First Embodiment

The method of optimizing a semiconductor device manufacturing process according to the first embodiment relates to optimization of a process condition. For example, the method may be applied to the case of manufacturing the same product by using the same photomask for the same product in a different exposing apparatus.

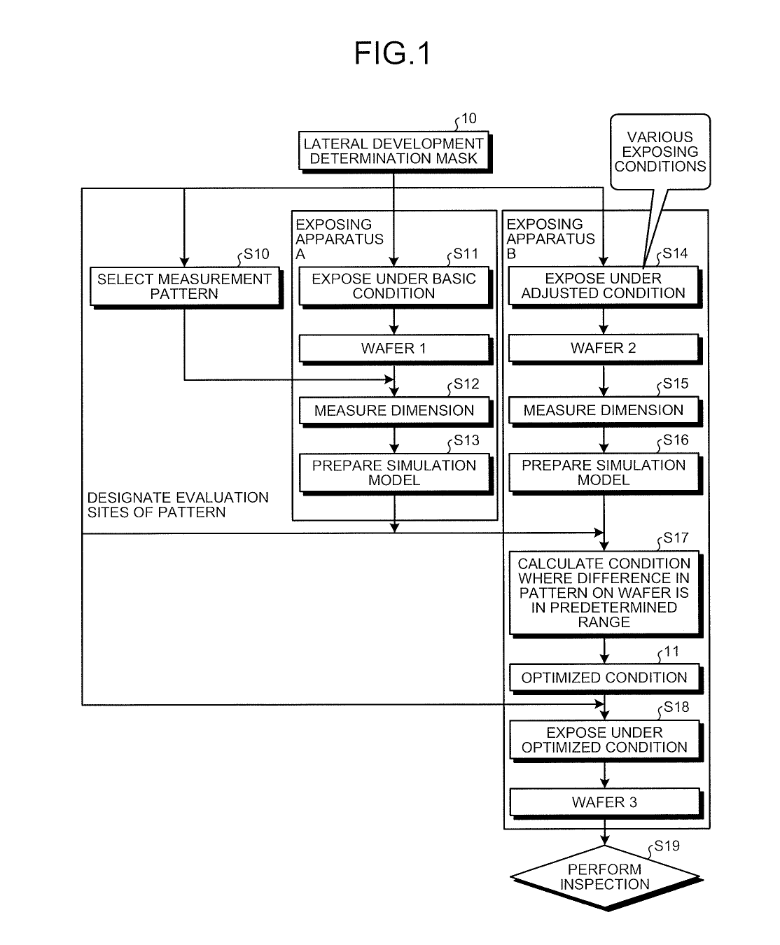

Before description of the method of optimizing a semiconductor device manufacturing process according to the embodiment, a method of optimizing a semiconductor device manufacturing process according to a comparative example will be described. FIG. 1 is a diagram illustrating a flow of illumination condition optimization by fine adjustment of the exposing parameters at the time of the exposing apparatus lateral development as the comparative example.

First, in the case of considering only a shape of the pattern in the layout, with respect to a lateral development determination mask 10 which is a mask including a plurality of yield risky patterns where dimension variation with respect to process variation in a lithography process is large and a process margin is small, for example, patterns such as an L shape or a crashed shape, selection of measurement sites of a measurement pattern is performed (Step S10).

Next, in the first exposing apparatus A, exposing is performed on the wafer 1 in a basic illumination condition (basic condition) by using the lateral development determination mask 10 for the optimization (Step S11); and dimension measurement is performed on the measurement pattern selected in Step S10 (Step S12). A general-purpose simulation model for estimating the pattern formed on the wafer by performing optical simulation from the mask pattern corresponding to a design layout is prepared from the dimension of the pattern obtained by the dimension measurement (Step S13). The simulation model is a model considering the characteristic and the illumination condition of the exposing apparatus used.

Actually, in the second exposing apparatus B where fine adjustment of the illumination condition is performed, exposing is performed on the wafer 2 by using the lateral development determination mask 10 in a basic illumination condition (basic condition) and a plurality of conditions (adjustment conditions) obtained by changing exposing parameters in various manners from the illumination condition (basic condition) (Step S14); the same dimension measurement as that of Step S12 is performed in the same manner as Step S12 (Step S15); and the simulation model is prepared (Step S16). Herein, the exposing parameters are obtained by changing one or more of various conditions including, for example, numerical aperture (NA), an illumination shape, and a tilt of a wafer to an illumination system.

Next, at a plurality of sites determined in advance as evaluation of the pattern on the wafer, an illumination condition of the exposing apparatus B, where a root mean square (RMS) of the difference of the dimension variation between the estimation pattern of the simulation model obtained in Step S13 and the varying estimation pattern of the simulation model obtained in Step S16 which varies with a change of the illumination condition of the exposing apparatus B, is minimized or an illumination condition of the exposing apparatus B, where the difference of the dimension variation is included in a predetermined range, is calculated as an optimized condition (Step S17). In other words, the optimized condition 11 is calculated with respect to various conditions including numerical aperture (NA), an illumination shape, and a tilt of a wafer to an illumination system (Step S17).

Under the optimized condition 11 determined by Step S17, exposing is performed again on the wafer 3 by the exposing apparatus B (Step S18); and inspection of the wafer 3 is performed (Step S19). In the optimized illumination condition, the dimension of the pattern in the lithography process is adjusted so as to become the most prospective value, so that an error occurring between the exposing apparatuses can be reduced. Therefore, since the dimension variation of the pattern shape caused by the change of the exposing apparatus can be suppressed, the photomask generated for the exposing apparatus A can be used in the exposing apparatus B without change of the photomask.

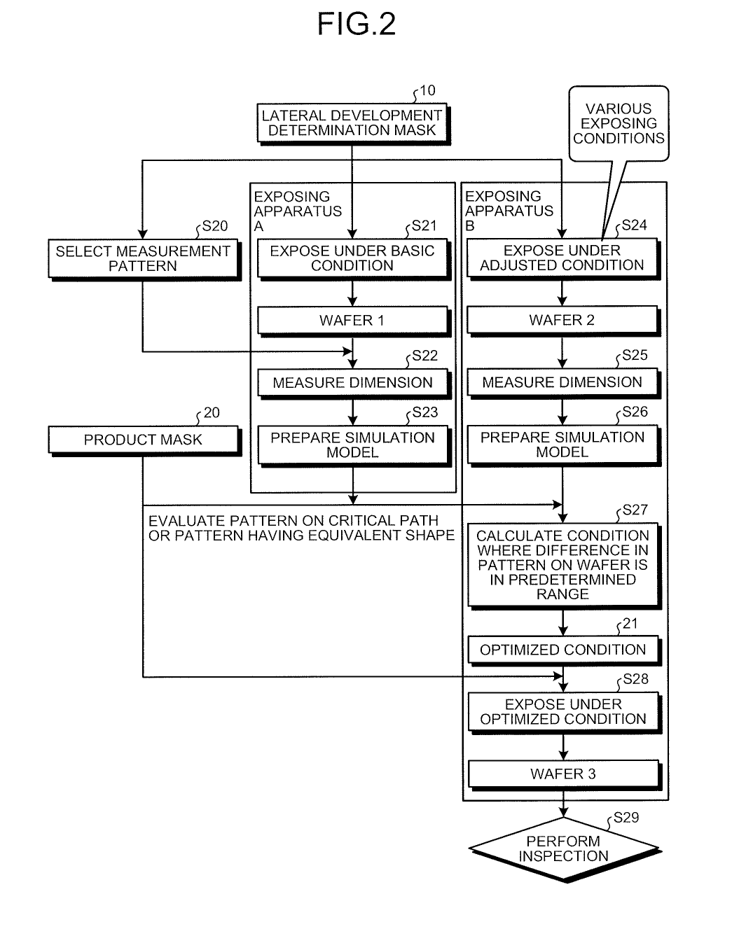

Next, FIG. 2 illustrates an example of a flow of illumination condition optimization in the method of optimizing a semiconductor device manufacturing process according to the embodiment.

First, with respect to the lateral development determination mask 10 which is a mask including a risky pattern where only a shape in the layout is to be considered and strict attention is to be paid to the dimension variation in terms of lithography, for example, a pattern where L shapes face each other, or the like, selection of the measurement pattern is performed (Step S20).

Next, in the first exposing apparatus A, exposing is performed on the wafer 1 in a basic illumination condition (basic condition) by using the lateral development determination mask 10 for the optimization (Step S21); and the dimension measurement is performed on the measurement pattern selected in Step S20 (Step S22). A general-purpose simulation model for estimating the pattern formed on the wafer from the mask pattern corresponding to a design layout is prepared from the dimension of the pattern obtained by the dimension measurement (Step S23).

Actually, in the second exposing apparatus B where fine adjustment of the illumination condition is performed, exposing is performed on the wafer 2 by using the lateral development determination mask 10 in a basic illumination condition (basic condition) and a plurality of conditions (adjustment conditions) obtained by changing exposing parameters in various manners from the illumination condition (basic condition) (Step S24); the same dimension measurement as that of Step S22 is performed (Step S25); and the simulation model is prepared (Step S26). Herein, the exposing parameters are obtained by changing one or more of various conditions including, for example, numerical aperture (NA), an illumination shape, and a tilt of a wafer to an illumination system. In addition, the process condition changed by the second exposing apparatus B may include one or more of an illumination shape, an illumination distribution, a polarization state, dynamic focus setting, a mask type, an exposing amount, aberration, a resist type, a thickness of a resist film, Post Exposure Bake (PEB), and a development condition.

In the embodiment, thereafter, at a plurality of sites determined in advance as evaluation of the pattern on the wafer, at the time of the calculation of an exposing condition, where RMS of the difference of the dimension variation between the estimation pattern of the simulation model obtained in Step S23 and the varying estimation pattern of the simulation model obtained in Step S26 which varies with a change of the illumination condition of the exposing apparatus B is minimized, or an exposing condition, where the difference of the dimension variation is included in a predetermined range, the calculation is performed by applying weighting to the pattern (critical path (C.P.)) which is critical in terms of the electrical characteristic in the product mask 20. In other words, the calculation is performed by applying weighting to the statistic amount based on the distribution of the difference.

The pattern which is critical in terms of the electrical characteristic denotes a circuit pattern where a variation margin of a pattern formed on a semiconductor substrate, for example, in order to maintain a desired electrical characteristic is smaller than a predetermined standard value. Timing analysis information obtained by timing check with respect to each of transistors, primitive cells, an instance as a set of cells, paths, and nets in a cell design stage and a chip design stage may be used as information for determining whether or not a circuit pattern extracted from circuit design data is critical in terms of an electrical characteristic. In addition, as detailed electrical characteristics, a power supply voltage drop due to IR-Drop, a delay time, a clock skew value, signal integrity, crosstalk, a process variation model, a hot electron effect, an electromigration effect, device reliability, lithography (Tr variation, wire line variation, and multi-Vth), etching, stress, temperature variation within a chip, or the like may be considered.

More specifically, the pattern corresponding to the circuit which is critical in terms of the electrical characteristic is extracted in the product mask 20, and the same pattern or a similar pattern is searched from the estimation pattern. At the time of the calculation of the optimized condition of the illumination condition of the exposing apparatus B, weighting is applied to the statistic amount based on the aforementioned distribution of the difference by taking into consideration the margin at the sites in terms of the electrical characteristic, and thereafter, the calculation of the optimized condition is performed (Step S27). In other words, in Step S17 of the comparative example, simply the total sum of the absolute value of the difference of the dimension variation is calculated, and on the contrary, in the embodiment, the total sum of the absolute value is calculated by applying the weighting to the difference of the dimension variation in the pattern corresponding to the circuit which is critical in terms of the electrical characteristic (Step S27). The exposing condition where the value of the total sum is minimized or equal to or less than a predetermined standard value among the exposing conditions which are changed with respect to the second exposing apparatus B is selected as an optimized exposing condition of the second exposing apparatus B. Therefore, at the time of determining the optimized condition, it is possible to suppress the dimension variation of the pattern corresponding to the circuit which is critical in terms of the electrical characteristic, so that the illumination condition of the exposing apparatus B where the electrical characteristic of devices are not changed as much as possible can be selected as the optimized condition. In addition, in the optimization, the data of the associated figures (transistors and wire lines) on the pattern of the circuit layout corresponding to the information on the set allowable dimension variation amount are generated, and the process condition may be searched for based on the data.

Therefore, in comparison with other patterns, in the pattern where the margin is small in terms of the electrical characteristic, it is possible to perform the calculation of the condition where improvement of the degree of importance of the pattern is considered. More specifically, with reference to the information on the margin of the pattern in terms of the electrical characteristic included in the design layout, the pattern is divided into a portion (pattern corresponding to the critical circuit) where the margin is small in terms of the electrical characteristic and fine adjustment is needed and a portion where the margin is large in terms of the electrical characteristic and the device characteristic is not greatly affected by some degree of the dimension variation. With reference to the critical pattern where the device characteristic is greatly affected, the optimized exposing condition of the exposing apparatus B is adjusted so as to satisfy the device design standard. Therefore, in the case of using the same photomask, with respect to a device generated by the exposing apparatus A, it is possible to suppress the variation of the device performance of a device generated by the exposing apparatus B.

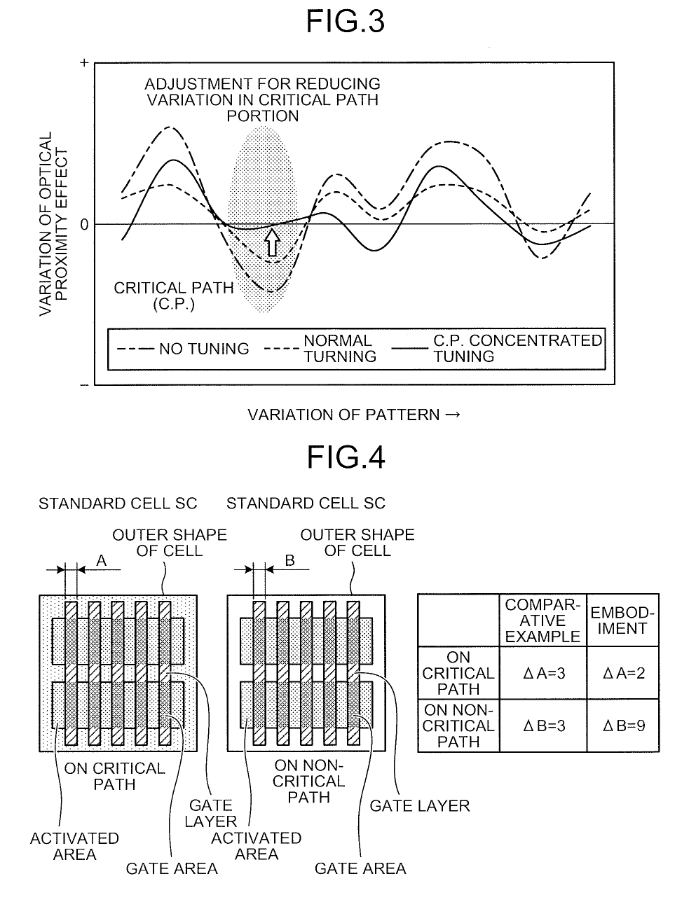

Under the optimized condition 21 (illumination condition) determined in this manner, exposing is performed again on the wafer 3 by the exposing apparatus B (Step S28); and inspection of the wafer 3 is performed (Step S29). FIG. 3 illustrates a conceptual diagram of tuning (the illumination condition optimization) which suppresses a change of the critical path to a minimum level according to the embodiment. The horizontal axis of FIG. 3 indicates a variation of a pattern, and the vertical axis indicates a variation of an optical proximity effect, that is, a dimension variation of a pattern occurring according to the change of the exposing apparatus. In the case of manufacturing the same product by using the same mask in a different exposing apparatus, in comparison with a comparison method (normal Tuning), in the illumination condition (C.P. concentrated Tuning) according to the embodiment concentrating the critical path which is optimized for each mask, a degree of risk of the electrical characteristic is reduced at the process side, so that it is possible to further improve the electrical characteristic yield.

More specifically, for example, as illustrated in FIG. 4, in the case of concentrating on a wire line width of a portion functioning as a gate of a transistor in a standard cell, considered are a variation ΔA of a wire line width A associated with a gate on a critical path and a variation ΔB of a wire line width B associated with a gate on a non-critical path. In the optimization of the comparative example, since the optimization is performed by concentrating on only the shape of the pattern, with respect to the width A and the width B, parameters of the exposing period are adjusted in the same manner. Therefore, for example, as illustrated in the right table of FIG. 4, in the optimization of the comparative example, the illumination condition is set so that the variation ΔA and the variation ΔB in the case of changing the exposing apparatus are equal to each other to some extent, that is, ΔA=ΔB=3.

However, according to the method of optimizing a semiconductor device manufacturing process according to the embodiment, the dimension variation can be suppressed so that, for example, ΔA=2 is set with respect to the wire line width A on the critical path. Therefore, it is possible to effectively improve the electrical characteristic yield of the circuit. In this case, if the electrical characteristic of the circuit can be secured, the standard for the dimension variation may be loosen so that, for example, ΔB=9 is set with respect to the wire line width B on the non-critical path.

In addition, with respect to portions of the method of optimizing a semiconductor device manufacturing process according to the embodiment, which can be executed by a computer, a non-transitory computer readable medium including instructions allowing the computer to execute the portions can be generated. Next, by allowing the computer to execute the instructions included in the non-transitory computer readable medium, it is possible to implement the optimization of a semiconductor device manufacturing process according to the embodiment.

### Second Embodiment

A method of optimizing a semiconductor device manufacturing process according to a second embodiment relates to Source Mask Optimization (SMO: a technique of optimization of a luminance distribution and shape of a light source and a mask shape). For example, the method can be applied to the case of manufacturing different product by using a different photomask corresponding to the different product in the same exposing apparatus. In this example, the optimization of the light source according to the SMO is performed based on the information on the electrical characteristic corresponding to the pattern on the mask. The SMO is a technique of obtaining a desired shape and dimension of the pattern on the wafer by simultaneously optimizing the illumination shape and the shape of the pattern on the mask. As the SMO in this example, performed is the optimization of the illumination shape.

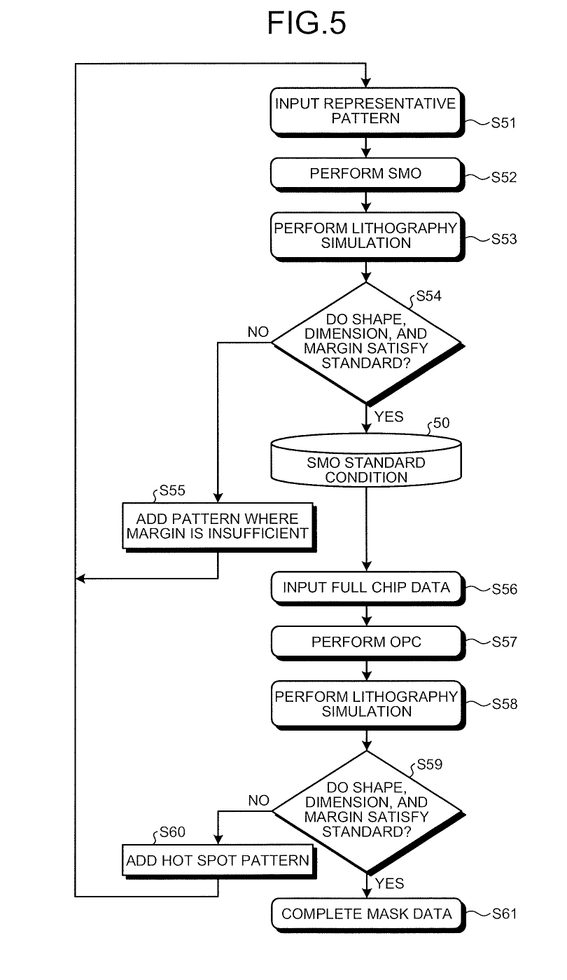

Before description of the method of optimizing a semiconductor device manufacturing process according to the embodiment, a method of optimizing a semiconductor device manufacturing process according to a comparative example will be described. FIG. 5 is a flowchart illustrating the method of optimizing a semiconductor device manufacturing process according to the comparative example.

With respect to the mask pattern where the margin is small within the design rule in the stage of lithography design input in Step S51 of FIG. 5, for example, the pattern which is a representative example of a line end space pattern of the generation, general lithography simulation is performed on the illumination shape which is the condition optimized (Step S52) by the SMO (Step S53). Next, it is determined whether or not the pattern which is expected to be resolved into an image on the wafer obtained in the lithography simulation satisfies a desired shape, dimension, and margin (Step S54). In the case where the shape, dimension, and margin do not satisfy the standard (No in Step S54), a risky pattern (a pattern where the process margin is sufficient) is added to the representative pattern (Step S55); the added representative pattern is input (Step S51); and the illumination shape is optimized again (Step S52). After that, lithography simulation is performed (Step S53); and if the shape, dimension, and margin satisfy the standard, (Yes in Step S54), the SMO standard condition 50 which is one illumination condition commonly optimized basically with respect to each generation of design rule can be obtained.

If the SMO standard condition 50 is obtained, the mask pattern data of a full chip is input (Step S56); the optimization of the mask shape taking into consideration an Optical Proximity Correction (OPC) is performed (Step S57); lithography simulation is performed, (Step S58); and it is determined whether or not the pattern on the wafer satisfies a desired shape, dimension, and margin (Step S59). In the case where the shape, dimension, and process margin of the pattern do not satisfies the standard (No in Step S59), a hot spot pattern which is a yield risky pattern actually not satisfying the standard is added to the representative pattern (Step S60); and the processes from Step S51 are performed again. In the case where the shape, dimension, and margin of the pattern satisfy the standard, the mask data is completed (Step S61).

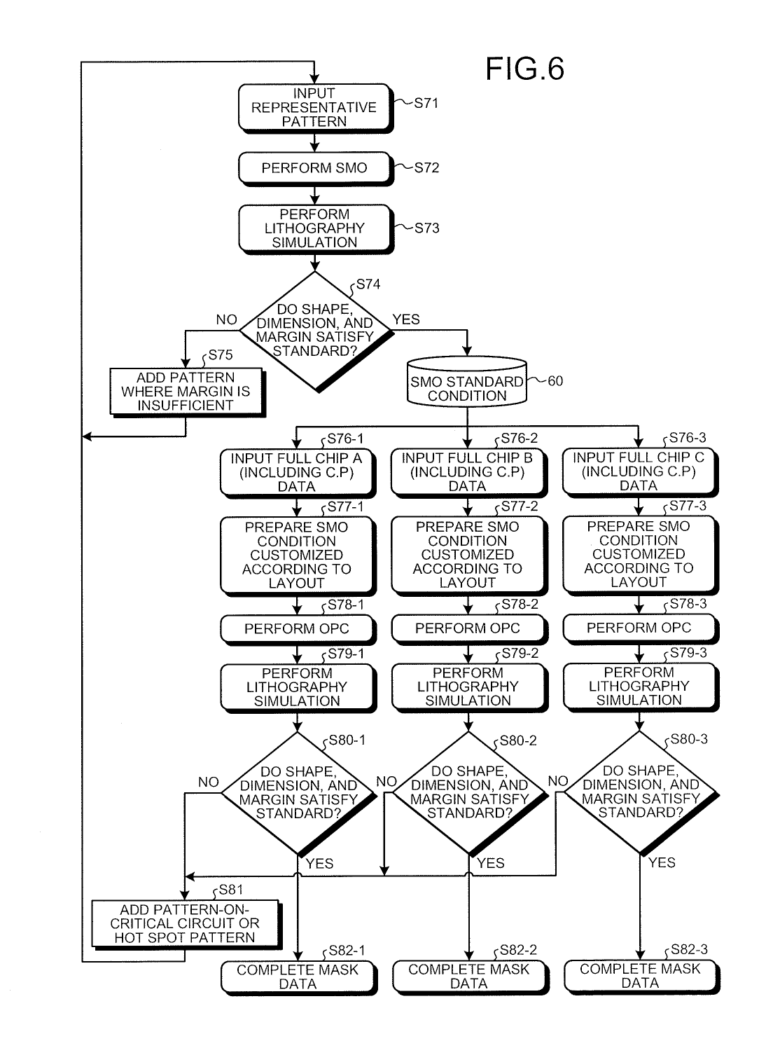

In the method of optimizing a semiconductor device manufacturing process according to the embodiment, as illustrated in the flow of FIG. 6, a basic condition (SMO standard condition 60) by taking into consideration the variation of the basic pattern is generated in advance, and the optimization is performed by using a different critical path for each product (SMO order-made production (Step S77)), so that a condition customized according to the layout of the product is prepared.

The flow of inputting of a representative pattern (Step S71), SMO (Step S72), lithography simulation (Step S73), determination whether or not the pattern on the wafer satisfies a desired shape, dimension, and margin (Step S74), addition of a risky pattern (a pattern where a process margin is insufficient) (Step S75), and acquisition of an SMO standard condition 60 illustrated in FIG. 6 is the same as that of the comparative example illustrated in FIG. 5.

In the flow of the embodiment illustrated in FIG. 6, for example, with respect to each chip of a plurality of chips A, B, and C, the mask pattern data of a full chip are input based on the SMO standard condition 60 (Steps S76-1, S76-2, and S76-3). The mask pattern data of each chip includes an individual critical path. After that, in the embodiment, the illumination condition of the exposing apparatus and the shape of the photomask are optimized based on the information on the electrical characteristic of the circuit pattern extracted from the circuit design data of each chip so that the circuit pattern where the variation margin of the pattern on the wafer for maintaining a desired electrical characteristic is smaller has a larger process margin (SMO order-made production) (Steps S77-1, S77-2, and S77-3). More specifically, SMO of each chip is performed by applying weighting to the critical path. For example, a layout included in a path, a cell, and a figure of which the degree of allowance in the dimension variation taking into consideration the electrical characteristic is small is extracted, and the optimization of the illumination shape is performed on the layout so that the dimension variation is within the degree of allowance.

After that, with respect to each chip, the optimization of the mask shape taking into consideration the OPC is performed (Steps S78-1, S78-2, and S78-3); lithography simulation is performed, (Steps S79-1, S79-2, and S79-3); and it is determined whether or not the pattern including the critical path on the wafer satisfies a desired shape, dimension, and margin (Steps S80-1, S80-2, and S80-3). As a result, in the case where the margin of the path which is electrically critical does not satisfy the standard with respect to the critical path (No in Steps S80-1, S80-2, and S80-3), the critical pattern is added to a representative pattern (Step S81); and the SMO standard condition 60 is generated again. In addition, in Steps S80-1, S80-2, and S80-3, it is determined whether or not the pattern obtained by considering only the shape satisfies the standard, and if the pattern does not satisfy the standard (No in Steps S80-1, S80-2, and S80-3), a hot spot pattern which is a risky pattern is added to the representative pattern (Step S81). In the case where the critical path satisfies the desired margin and no hot spot pattern is detected in Steps S80-1, S80-2, and S80-3 (Yes in Steps S80-1, S80-2, and S80-3), the mask data is completed (Steps S82-1, S82-2, and S82-3). Therefore, it is possible to perform order-made production according to the optimization concentrating on the critical path of each product.

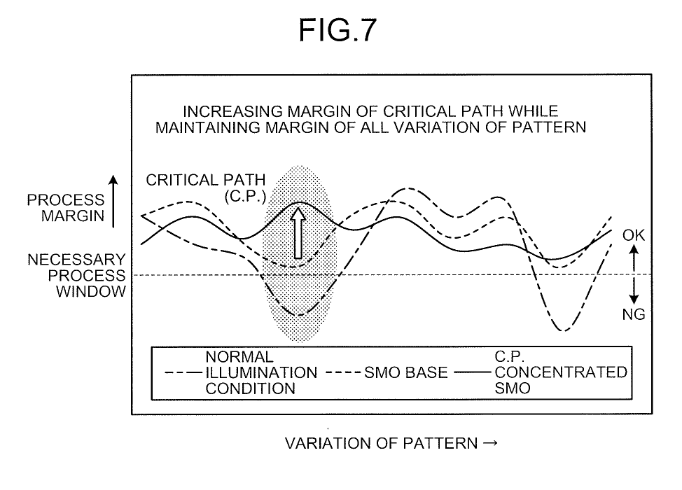

FIG. 7 schematically illustrates a behavior where a process condition concentrating on the pattern which is electrically critical can be selected in the method of optimizing a semiconductor device manufacturing process according to the embodiment illustrated in FIG. 6. Illustrated is an image of the case of improving a margin by specifying the critical path. The horizontal axis of FIG. 7 indicates a variation of a pattern, and the vertical axis indicates a process margin. Although the process margin is a two-dimensional value including an exposing amount and a focus value, in this case, the process margin is schematically illustrated in one dimension in terms of whether or not the margin can be taken from a process window. In a general illumination condition, even in the case where the pattern where a margin cannot be taken from a necessary process window occurs, a margin which is larger than the necessary process window can be secured by the SMO standard condition which is an illumination condition optimized commonly in the generations of the design rules obtained by performing the SMO. By the SMO according to the embodiment where the critical path is specified, it is possible to secure the margin over all the variations of the pattern and to obtain a sufficiently large margin with respect to the critical path.

In addition, with respect to portions of the method of optimizing a semiconductor device manufacturing process according to the embodiment, which can be executed by a computer, a non-transitory computer readable medium including instructions allowing the computer to execute the portions can be generated. Next, by allowing the computer to execute the instructions included in the non-transitory computer readable medium, it is possible to implement the optimization of a semiconductor device manufacturing process according to the embodiment.

### Third Embodiment

A method of optimizing a semiconductor device manufacturing process according to a second embodiment relates to adjustment of an exposing amount for adjusting a distribution of a dimension variation of a pattern on a wafer, in other words, to an exposing amount adjustment map of an exposing machine.

Before description of the method of optimizing a semiconductor device manufacturing process according to the embodiment, a method of optimizing a semiconductor device manufacturing process according to a comparative example will be described. In this example, the dimension variation on the wafer is reduced by generating the exposing amount adjustment map.

A photomask is generated based on design layout, and the distribution of the dimension variation of the pattern on the photomask is measured. Next, a Mask Error Enhancement Factor (MEEF) is obtained through an experiment or by using lithography simulation or the like, and the distribution of the dimension variation of the pattern on the wafer is measured. The MEEF is a value indicating how many times the dimension variation on the mask is magnified on the wafer when the mask is reduced to a same-magnification mask, and is expressed by a relation of (dimension variation on wafer)=MEEF×(dimension variation on mask).

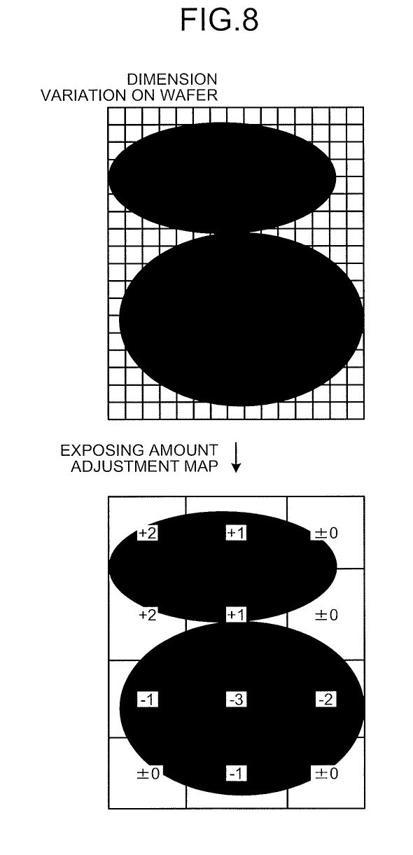

Next, the exposing amount adjustment map of the exposing machine is generated so that the dimension variation of the pattern on the wafer is decreased, and the exposing is performed based on the exposing amount adjustment map. FIG. 8 illustrates an example of generating of the exposing amount adjustment map by taking into consideration the dimension variation on the wafer. By taking into consideration the dimension variation on the wafer in the comparative example and taking into consideration the wide/narrow variation of the dimension in each of the adjustment areas, the exposing amount is adjusted so that more patterns are finished with the dimension in the adjustment area, as illustrated in the exposing amount adjustment map in the lower portion of FIG. 8. In other words, the adjustment is performed with respect to each of the portion areas which are partitioned in a two-dimensional mesh.

At this time, in the comparative example, although the dimension of the pattern is considered, the circuit characteristic and the electrical characteristic in design are not considered. For this reason, the pattern which is not important in terms of circuits is finished with a desired dimension, and on the other hand, there is a problem in that the important pattern may not be finished with the dimension and a desired circuit characteristic may not be achieved.

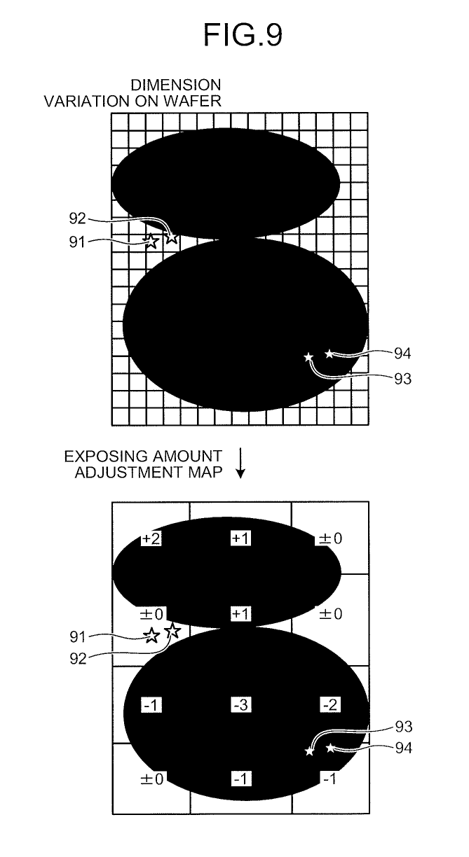

Therefore, in the embodiment, when the exposing amount adjustment map is generated, the position information of the pattern on the circuit which is critical in terms of the circuit characteristic and the electrical characteristic is considered. The pattern on the circuit which is critical in terms of the circuit characteristic and the electrical characteristic is a circuit pattern where the variation margin of the pattern formed on the wafer is smaller than a predetermined value based on the electrical characteristic information extracted from the circuit design data in order to maintain a predetermined electrical characteristic. For example, in FIG. 9, the exposing amount in the exposing amount adjustment area is adjusted in the exposing amount adjustment map illustrated in the lower portion of FIG. 9 with reference to the positions of the patterns 91 to 94 on the critical circuit so that the dimension of the pattern of the critical circuit is finished with a desired dimension.

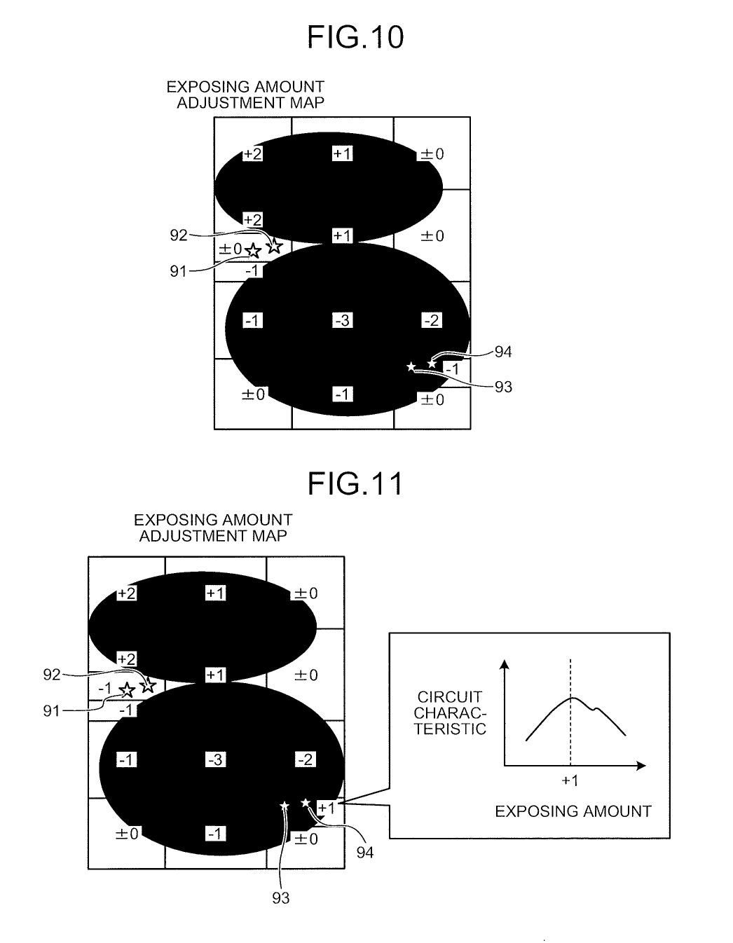

In another example of the embodiment, as illustrated in the exposing amount adjustment map of FIG. 10, by further subdividing the exposing amount adjustment area of the area including the pattern of the critical circuit and performing setting on each subdivided area with reference to the positions of the patterns 91 to 94 on the critical circuit, the exposing amount in the adjustment area is adjusted so that the pattern on the critical circuit is finished with a desired dimension.

In still another example of the embodiment, as illustrated in the exposing amount adjustment map of FIG. 11, with respect to the patterns 91 to 94 on the critical circuit, the exposing amount is adjusted to a value capable of obtaining a good circuit characteristic with reference to the exposing amount and the circuit characteristic in a proximate area. For example, with respect to an electromigration (EM) risk site, the value in the exposing amount adjustment area is adjusted to a value which is finished to be large so that a current density is not locally increased.

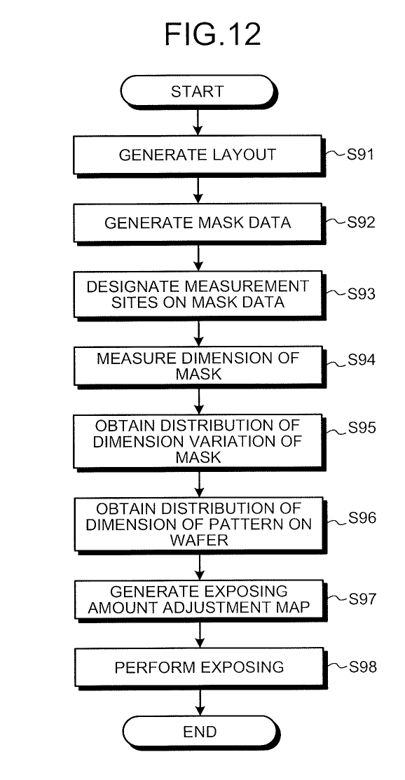

FIG. 12 illustrates a flowchart of the exposing amount adjustment method according to the embodiment described hereinbefore. First, a layout is generated from given design data (Step S91). Next, mask data is generated (Step S92), and dimension measurement sites in the mask data is designated (Step S93). The dimension of the mask at the sites designated in Step S93 is measured (Step S94), and a distribution of the dimension variation of the mask is obtained (Step S95). Herein, a distribution of dimension of the pattern on the wafer is obtained from the obtained distribution of the dimension variation of the mask by using the aforementioned MEEF (Step S96). As described above, an exposing amount map is generated from the distribution of dimension of the pattern on the wafer by taking into consideration the position information of the pattern on the circuit which is critical in terms of the circuit characteristic and the electrical characteristic (Step S97). By performing the exposing by adjusting the exposing amount in each of the areas divided in two dimensions based on the exposing amount map (Step S98), it is possible to generate the pattern on the critical circuit on the wafer as a pattern of maintaining a desired electrical characteristic.

In the embodiment, the exposing dose optimization is performed based on the information on the electrical characteristic corresponding to the pattern by using a doze mapping method in the exposing. The dose variation is measured in a slit direction and a scan direction on the exposing surface, and the exposing is performed by mapping optimized dozes to sites.

A corrected value of the exposing amount is calculated from the distributions of dimensions of the patterns on the mask and the wafer in the comparative example, and exposing dose is determined. Since the dose is determined without consideration of the sites which are important in terms of circuits and the sites where the margin is small in terms of the electrical characteristic, there is a risk in that the electrical characteristic margin is insufficient or defects occur in terms of the device characteristic.

In the embodiment, the mapping of the exposing dose is performed by taking into consideration the sites which are important in terms of circuits and the sites where the margin is small in terms of the electrical characteristic. If needed, with respect to the sites where the margin is small in terms of the electrical characteristic, the dose is adjusted in such a direction that the margin is increased. Therefore, the dimension accuracy at the sites which are electrically important is improved, so that effects of improvement of performance/yield and reduction of chip costs are expected.

In addition, in the first to third embodiments, in cell design and chip design, a net which is critical in terms of the electrical characteristic, cell instance, transistor, and figure are extracted, and inspection is performed by taking into consideration the process variation, so that it is possible to allocate the degrees of allowance to each of the net, the cell instance, the transistor, and the figure. In addition, at the time of completion of the design data, the net, the cell instance, the transistor, the figure and the corresponding degrees of allowance thereof are taped out together with the layout and the data. At the time of determining the illumination condition or the like of the exposing apparatus in the manufacturing of the semiconductor device, fine adjustment of the exposing parameter is performed by taking into consideration the degree of process allowance of the site where the margin is small in terms of the electrical characteristic, such as a path where the timing margin is small.

Therefore, a necessary site can be allowed to have a necessary margin by taking into consideration the electrical characteristic and the degree of process allowance of each pattern, so that it is possible to efficiently manufacture a semiconductor device which performs electrically correct circuit operations. In other words, it is possible to improve a yield in terms of the electrical characteristic, and it is possible to manufacture a semiconductor circuit having a high quality layout and device performance with much shorter Turn Around Time (TAT). Therefore, it is possible to reduce chip costs.

In addition, with respect to portions of the method of optimizing a semiconductor device manufacturing process according to the embodiment, which can be executed by a computer, a non-transitory computer readable medium including instructions allowing the computer to execute the portions can be generated. Next, by allowing the computer to execute the instructions included in the non-transitory computer readable medium, it is possible to implement the optimization of a semiconductor device manufacturing process according to the embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of optimizing a semiconductor device manufacturing process in which a pattern is formed on a semiconductor substrate based on circuit design data by an exposing process using a photomask generated from the circuit design data, comprising:
at the time of calculation of a statistic amount based on a distribution of differences at a plurality of sites, which are determined in advance, between a pattern formed on the semiconductor substrate by a first exposing apparatus using the photomask in a first exposing condition and a pattern formed on the semiconductor substrate by a second exposing apparatus using the photomask in a second exposing condition, calculating the statistic amount after applying weighting to the differences based on information on an electrical characteristic extracted from the circuit design data; and
repeating the calculating with the second exposing condition being changed, and selecting an exposing condition in which the total sum becomes a minimum value or equal to or less than a predetermined standard value as an optimized exposing condition of the second exposing apparatus among the changed second exposing conditions.

2. A method of optimizing a semiconductor device manufacturing process in which a pattern is formed on a semiconductor substrate based on circuit design data by an exposing process using a photomask generated from the circuit design data, comprising:
at the time of optimization of both an illumination condition of an exposing apparatus and a shape of the photomask generated from the circuit design data so that a process margin of a circuit pattern formed based on the circuit design data on the semiconductor substrate is increased, selecting the illumination condition and the shape of the photomask based on information on an electrical characteristic extracted from the circuit design data so that the process margin is further increased with respect to the circuit pattern where variation margin for maintaining a predetermined electrical characteristic is smaller.

3. The method of optimizing a semiconductor device manufacturing process according to claim 2,
wherein the optimization is performed on a plurality of the circuit design data which are to be formed in a plurality of the semiconductor substrates.

4. A method of optimizing a semiconductor device manufacturing process in which a pattern is formed on a semiconductor substrate based on circuit design data by an exposing process using a photomask generated from the circuit design data, comprising:
at the time of adjustment of an exposing amount so that a dimension variation of a circuit pattern formed on the substrate by an exposing apparatus capable of adjusting the exposing amount independently with respect to a plurality of the portion areas on the semiconductor substrate by using the photomask is decreased, adjusting the exposing amount based on information on an electrical characteristic extracted from the circuit design data so that the dimension variation is further decreased with respect to the portion areas including the circuit pattern where variation margin for maintaining a predetermined electrical characteristic is smaller than a predetermined value.

5. The method of optimizing a semiconductor device manufacturing process according to claim 4,
wherein the portion areas including the circuit pattern where the variation margin is smaller than the predetermined value are further divided, and the exposing amount is adjusted with respect to each of the newly divided areas.

6. A method of manufacturing a semiconductor device, comprising:
at the time of calculation of a statistic amount based on a distribution of differences at a plurality of sites, which are determined in advance, between a pattern formed on a semiconductor substrate by a first exposing apparatus using a photomask generated from circuit design data in a first exposing condition and a pattern formed on the semiconductor substrate by a second exposing apparatus using the photomask in a second exposing condition, calculating the statistic amount after applying weighting to the differences based on information on an electrical characteristic extracted from the circuit design data;
repeating the calculating process with the second exposing condition being changed, and selecting an exposing condition in which the total sum becomes a minimum value or equal to or less than a predetermined standard value as an optimized exposing condition of the second exposing apparatus among the changed second exposing conditions; and
forming a pattern based on the circuit design data on the semiconductor substrate by an exposing process using the photomask in the optimized exposing condition.

7. A method of manufacturing a semiconductor device, comprising:
at the time of optimization of both an illumination condition of an exposing apparatus and a shape of a photomask generated from the circuit design data so that a process margin of a circuit pattern formed based on the circuit design data on the semiconductor substrate is increased,
selecting the illumination condition and the shape of the photomask based on information on an electrical characteristic extracted from the circuit design data so that the process margin is further increased with respect to the circuit pattern where variation margin for maintaining a predetermined electrical characteristic is smaller; and
forming a pattern based on the circuit design data on the semiconductor substrate by an exposing process using the photomask.

8. The method of manufacturing a semiconductor device according to claim 7,
wherein the optimization is performed on a plurality of the circuit design data which are to be formed in a plurality of the semiconductor substrates.

9. A method of manufacturing a semiconductor device, comprising:
at the time of adjustment of an exposing amount so that a dimension variation of a circuit pattern formed on a semiconductor substrate by an exposing apparatus capable of adjusting the exposing amount independently with respect to a plurality of the portion areas on the semiconductor substrate by using a photomask generated from circuit design data is decreased,
adjusting the exposing amount based on information on an electrical characteristic extracted from the circuit design data so that the dimension variation is further decreased with respect to the portion areas including the circuit pattern where variation margin for maintaining a predetermined electrical characteristic is smaller than a predetermined value; and
forming a pattern based on the circuit design data on the semiconductor substrate by an exposing process using the photomask with the adjusted exposing amount.

10. The method of manufacturing a semiconductor device according to claim 9,
wherein the portion areas including the circuit pattern where the variation margin is smaller than the predetermined value are further divided, and the exposing amount is adjusted with respect to each of the newly divided areas.

11. A non-transitory computer readable medium comprising instructions that cause a computer to execute:
at the time of calculation of a statistic amount based on a distribution of differences at a plurality of sites, which are determined in advance, between a pattern formed on a semiconductor substrate by a first exposing apparatus using a photomask generated from circuit design data in a first exposing condition and a pattern formed on the semiconductor substrate by a second exposing apparatus using the photomask in a second exposing condition, calculating the statistic amount after applying weighting to the differences based on based on information on an electrical characteristic extracted from the circuit design data; and
repeating the calculating process with the second exposing condition being changed, and selecting an exposing condition in which the total sum becomes a minimum value or equal to or less than a predetermined standard value as an optimized exposing condition of the second exposing apparatus among the changed second exposing conditions.

12. A non-transitory computer readable medium comprising instructions that cause a computer to execute:
at the time of optimization of both an illumination condition of an exposing apparatus and a shape of the photomask generated from the circuit design data so that a process margin of a circuit pattern formed based on the circuit design data on the semiconductor substrate is increased,
selecting the illumination condition and the shape of the photomask based on information on an electrical characteristic extracted from the circuit design data so that the process margin is further increased with respect to the circuit pattern where variation margin for maintaining a predetermined electrical characteristic is smaller.

13. The non-transitory computer readable medium according to claim 12,
wherein the optimization is performed on a plurality of the circuit design data which are to be formed in a plurality of the semiconductor substrates.

14. A non-transitory computer readable medium comprising instructions that cause a computer to execute:
at the time of adjustment of an exposing amount so that a dimension variation of a circuit pattern formed on a semiconductor substrate by an exposing apparatus capable of adjusting the exposing amount independently with respect to a plurality of the portion areas on the semiconductor substrate by using a photomask generated from circuit design data is decreased, adjusting the exposing amount based on information on an electrical characteristic extracted from the circuit design data so that the dimension variation is further decreased with respect to the portion areas including the circuit pattern where variation margin for maintaining a predetermined electrical characteristic is smaller than a predetermined value.

15. The non-transitory computer readable medium according to claim 14,
wherein the portion areas including the circuit pattern where the variation margin is smaller than the predetermined value are further divided, and the exposing amount is adjusted with respect to each of the newly divided areas.
